(19) United States
(12) Patent Application Publication
(10) Pub. No.: US 2009/0255383 A1
(43) Pub. Date: Oct. 15, 2009

(54) IMPACT SCREWDRIVER

(76) Inventor: CHIH-CHING HSIEH, Taichung City (TW)

Correspondence Address: Chien-Hui Su, P. O. Box 70-121 Taichung, Taichung City, 40899, TW

(21) Appl. No.: 12/101,102

(22) Filed: Apr. 10, 2008

(51) Int. Cl. B25B 23/02

(52) U.S. Cl. 81/451

(57) ABSTRACT

An impact screwdriver includes: a handle has a spindle mounted therein. The spindle has a first end and a second end extending to an outer surface of the handle, a percussion portion is mounted on the first end of the spindle for loading impact, a tank is axially defined in the spindle from the second end of the spindle, a guiding structure is defined in an inner periphery of the tank, an elastic member and a driving shank is sequentially mounted in the tank for cooperating each other, a boss is positioned on the driving shank and installed into the guiding structure to make the guiding structure drive the driving shank when the percussion portion is impacted.

### FIELD OF THE INVENTION

The present invention relates to an impact screwdriver, and more particularly to an impact screwdriver that further drives a screw when being longitudinally impacted.

### BACKGROUND OF THE INVENTION

Referring to U.S. Pat. No. 6,860,180, “Screwdriver provided with percussion mechanism to facilitate the unfastening and the fastening of screw” is disclosed. In that a screwdriver comprises a handle and a shank. The handle is provided at a head end of the handle with a percussion block. The shank is put through the interior of the handle such that one end of the shank is fastened with the percussion block, and the other end of the shank extends out of the other end of the handle. The shank is provided on the other end thereof with a percussion-rotation mechanism which is in turn fastened with a tip. The mechanism enables the tip to turn instantaneously at the time when the percussion block is impacted.

Above mentioned structure provides a V-shaped slot for being inserted by a boss, that the boss follows the V-shaped slot when the shank is fastened with the percussion block. However, it still has some drawbacks. First, the boss must overcomes the top of the V-shaped slot to rotate the shank and move downward continually, if a impact power is not enough to overcome the top of the V-shaped slot, the boss will fall back or get stuck, wherein the shank is rotated back and unfastens the screw. Second, a direction for fastening a screw usually is clockwise and a direction for unfastening the screw is anti-clockwise; the prior art provides the direction of anti-clockwise for unfastening the screw, it is only used for a screw of normal spiral type, but a spiral of a screw is opposite for assembling a bearing of a motor or a fanner, thereof the prior art cannot fasten the screw of the opposite spiral.

Thus there is an eager demand for a novel design which can improve the defect in the prior art.

### SUMMARY OF THE INVENTION

The main objective of the present invention is to provide an improved impact screwdriver that further drives a screw when being longitudinally impacted.

To achieve the objective, the impact screwdriver in accordance with the present invention comprises a handle having a spindle mounted therein. The spindle has a first end and a second end extending to an outer surface of the handle. A percussion portion is mounted on the first end of the spindle for loading impact. A tank is axially defined in the spindle from the second end of the spindle. A guiding structure is defined in an inner periphery of the tank. An elastic member and a driving shank are sequentially mounted in the tank for cooperating each other. A boss is positioned on the driving shank and installed into the guiding structure to make the guiding structure drive the driving shank when the percussion portion is impacted.

The guiding structure according to the present invention limits the boss of driving shank installed therein for changing a longitudinal impact to be a rotatively movement, in that, it can fasten or unfasten a screw with impact. Further, in the preferred embodiment of the present invention, the guiding structure is composed by a spiral groove, an arc groove, or double spiral grooves, it provides different effects. For example, the spiral groove provides a longer longitudinal movement for increasing a torque power of the driving shank. The arc groove provides a shorter longitudinal movement for decreasing the rotating time and rotating circles of the driving shank. The double spiral grooves provide a clockwise or anti-clockwise rotation of the driving shank for fastening or unfastening the screw. Wherein, the impact screwdriver of the present invention can be used for fastening or unfastening a screw of a normal spiral or an opposite spiral.

The various objectives and advantages of the present invention will be more readily understood from the following detailed description when read in conjunction with the appended drawing.

### BRIEF DESCRIPTION OF THE DRAWINGS

FIG. 1 is a partially exploded perspective view of a first embodiment of an impact screwdriver in accordance with the present invention;

FIG. 2 is a plan view of the impact screwdriver in accordance with the present invention;

FIG. 3 is a plan view of the impact screwdriver in FIG. 2, wherein the broken lines show the structure of a spindle in detail;

FIG. 4, FIG. 5, and FIG. 6 are the operational plan views of the first embodiment of the present invention;

FIG. 7 is a plan view of a second embodiment of the impact screwdriver of the present invention, wherein the broken lines show the boss received to an arc groove of the spindle;

FIG. 8 is a plan view of a third embodiment of the impact screwdriver of the present invention, wherein the broken lines show the boss received to double spiral grooves of the spindle;

FIG. 9 and FIG. 10 are operational views of the impact screwdriver in FIG. 8;

FIG. 11 is a plan view of a fourth embodiment of the impact screwdriver of the present invention, wherein the broken lines show the boss received to double spiral grooves of the spindle;

FIG. 12 and FIG. 13 are operational views of the impact screwdriver in FIG. 11.

### DETAILED DESCRIPTION OF THE INVENTION

In order that those skilled in the art can further understand the present invention, a description will be provided in details below. However, these descriptions and the appended drawings are only used for those skilled in the art to understand the objects, features, and characteristics of the present invention, but not to be used to confine the scope and spirit of the present invention defined in the appended claims.

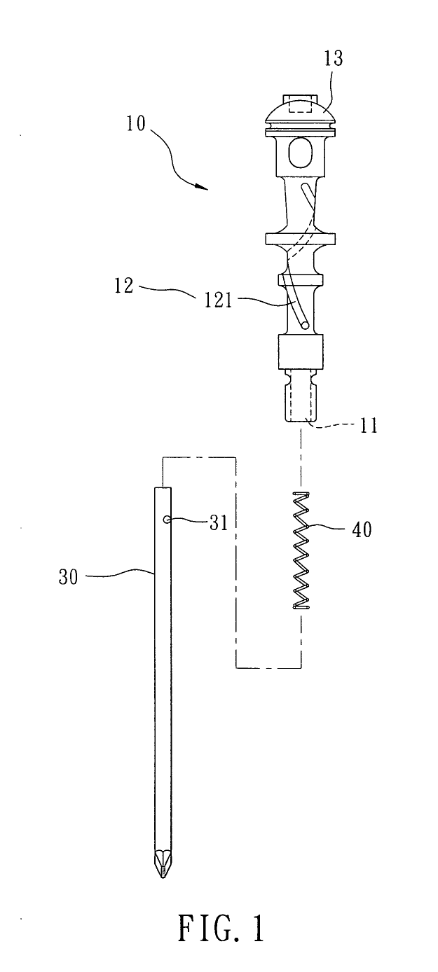

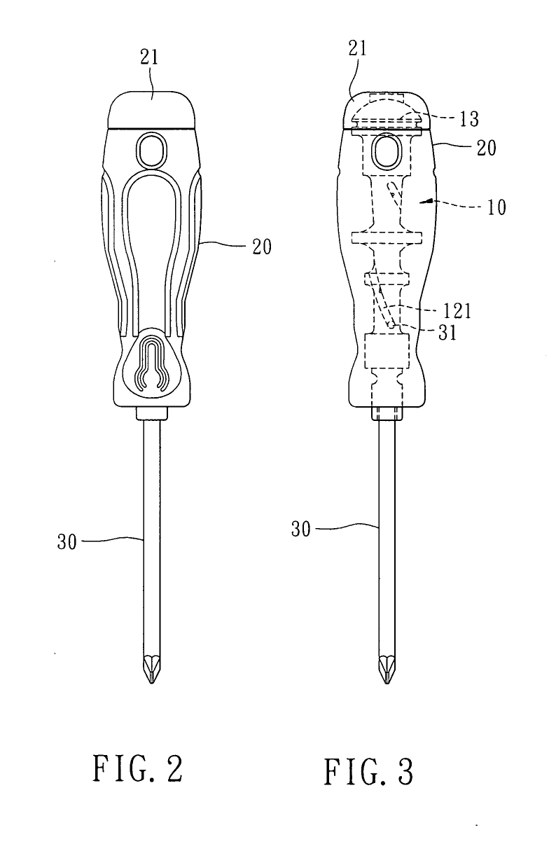

Referring the first embodiment of FIG. 1 to FIG. 6, a first embodiment of an impact screwdriver in accordance with the present invention is illustrated.

In the embodiment, the impact screwdriver comprises a handle 20 formed by injection molding. A spindle 10 is mounted in the handle 20 and has a first end and a second end extending to an outer surface of the handle 20. A percussion portion 13 is longitudinally mounted on the first end of the spindle 10 for loading impact. A high hardness percussion block 21 (e.g. steel) is mounted on the handle 20 and co-axially corresponds to the percussion portion 13 of the spindle 10 for coating the percussion portion 13. A tank 11 is axially defined in the spindle 10 from the second end of the spindle 10. A guiding structure 12 is disposed in an inner periphery of the tank 11. In the embodiment, the guiding structure 12 is a spiral groove 121.

An elastic member 40 and a driving shank 30 are sequentially mounted in the tank 11 for cooperating each other. A boss 31 is positioned on the driving shank 30 and received to the spiral groove 121.

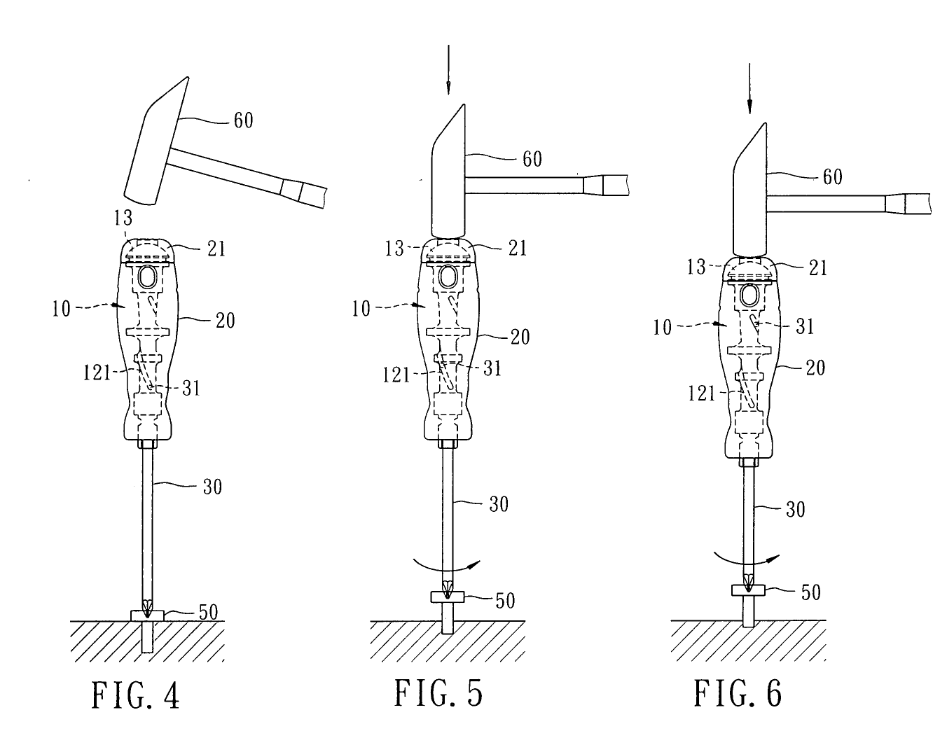

As show in FIG. 4 to FIG. 6 that show the driving shank 30 of the screwdriver contacts with a screw 50, the elastic member 40 is compressed and the driving shank 30 draws back into the tank 11 when the percussion block 21 is hit by a hammer 60. The boss 31 is moved along the spiral groove 121 and the driving shank 20 longitudinally moved along an opposite direction of a force which the hammer 60 hits the percussion block 21, thereby, the driving shank 30 is anti-clockwise rotated for unfastening the screw 50.

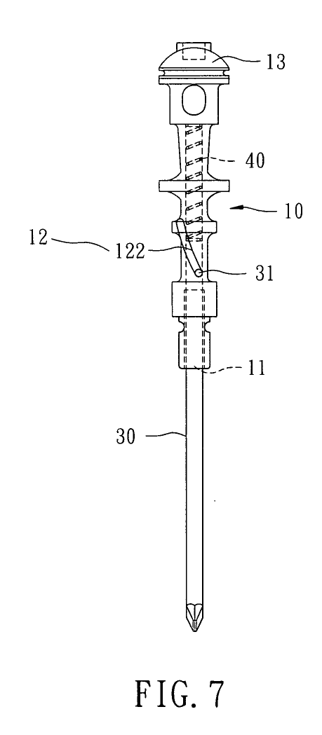

FIG. 7 shows a second embodiment of the guiding structure 12 of the present invention. In the embodiment, the guiding structure 12 is an arc groove 122 and has a longitudinal distance shorter than that of the spiral groove 121 of the first embodiment for decreasing the rotating time and the rotating circles of the driving shank 30 when the percussion portion 13 is impacted.

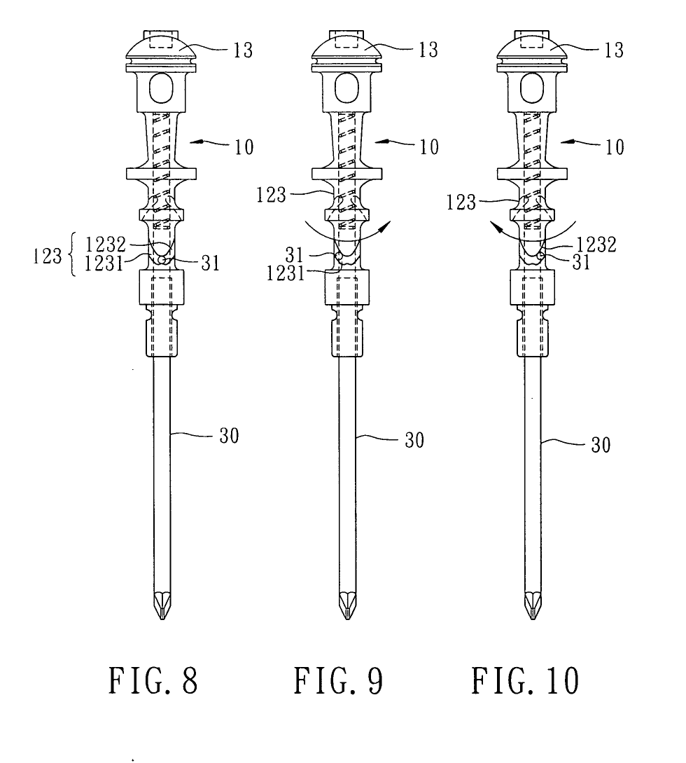

FIG. 8, FIG. 9 and FIG. 10 show a third embodiment of the guiding structure 12 of the present invention. In the embodiment, the guiding structure 12 is composed by double spiral grooves 123, which includes a left side groove 1231 and a right side groove 1232, for providing fastening or unfastening effect. With reference to FIG. 9, for fastening the screw, the handle 20 is anti-clockwise rotated for pushing the boss 31 of the driving shank 30 into a left side groove 1231 of the double spiral groove 123. As a result, the driving shank 30 is clockwise rotated when the percussion portion 13 is impacted. With reference to FIG. 10, for unfastening the screw, the handle 20 is clockwise rotated for pushing the boss 31 of the driving shank 30 into a right side groove 1232 of the double spiral groove 123. As a result, the driving shank 30 is anti-clockwise rotated when the percussion portion 13 is impacted.

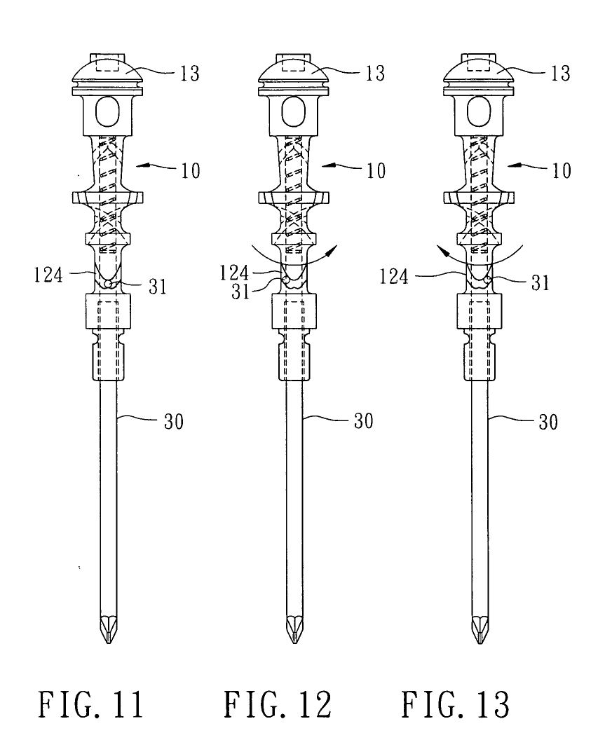

FIG. 11, FIG. 12 and FIG. 13 show a fourth embodiment of the guiding structure 12 of the present invention. In the embodiment, the guiding structure 12 is composed by double spiral grooves 124 for providing fastening or unfastening effect. The double spiral grooves 124 has a longitudinal distance longer than that of the double spiral groove 123 of the third embodiment for increasing rotating circles of the driving shank 30 when the percussion portion 13 is impacted.

However, above mentioned embodiments are just examples of the present invention, they are not confined the scope of the present invention.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An impact screwdriver comprising:
a handle has a spindle mounted therein, the spindle having a first end and a second end extending to an outer surface of the handle, a percussion portion mounted on the first end of the spindle for loading impact, a tank axially defined in the spindle from the second end of the spindle, a guiding structure defined in an inner periphery of the tank; and
an elastic member and a driving shank sequentially mounted in the tank for cooperating each other, a boss positioned on the driving shank and installed into the guiding structure to make the guiding structure drive the driving shank when the percussion portion is impacted.

2. The impact screwdriver as claimed in claim 1, wherein the guiding structure is a spiral groove,

3. The impact screwdriver as claimed in claim 1, wherein the guiding structure is composed by double spiral grooves.

4. The impact screwdriver as claimed in claim 1 further comprising a percussion block mounted on the handle and co-axially corresponding to the percussion portion of the spindle.

5. The impact screwdriver as claimed in claim 1, wherein the handle is formed by injection molding.
